(19) United States
(12) Patent Application Publication
(10) Pub. No.: US 2024/0283764 A1
(43) Pub. Date: Aug. 22, 2024

(54) COMMUNICATION SYSTEM, METHOD, AND PROGRAM

(71) Applicant: Nippon Telegraph and Telephone Corporation, Tokyo (JP)

(72) Inventors: Maiko IMOTO, Musashino-shi, Tokyo (JP); Teruhisa INOUE, Musashino-shi, Tokyo (JP); Ushio SHIBUSAWA, Musashino-shi, Tokyo (JP); Shunsuke TAKAMIYA, Musashino-shi, Tokyo (JP); Soichiro UCHIDA, Musashino-shi, Tokyo (JP); Fanglu XIE, Musashino-shi, Tokyo (JP)

(21) Appl. No.: 18/569,453

(22) PCT Filed: Jun. 21, 2021
(86) PCT No.: PCT/JP2021/023477

§ 371 Date: Dec. 12, 2023

(51) Int. Cl. H04L 51/21; G06F 40/35

(52) U.S. Cl. CPC H04L 51/21; G06F 40/35

(57) ABSTRACT

A communication system communicating with a plurality of client terminals via a communication line includes: a first reception unit configured to receive content transmitted from a first client terminal among the plurality of client terminals via the communication line; a posting unit configured to write the content on an electronic bulletin board which the plurality of client terminals are able to browse; a second reception unit configured to receive a message generated by one of the plurality of client terminals via the communication line with respect to the content written on the electronic bulletin board; a determination unit configured to determine whether the message is a message having positive details or a message having negative details based on details of the message; and a transmission unit configured to transmit the message to have the positive details to the first client terminal via the communication line.

### TECHNICAL FIELD

Embodiments of the present invention relate to a communication system, method, and program for filtering a negative message among messages exchanged using, for example, a social networking service (SNS).

### BACKGROUND ART

In recent years, when creators such as cartoonists, novelists and illustrators create content such as cartoons, novels, and illustrations, the content or content which is being created is disclosed using an SNS in order to increase the number of people carrying out processes of maintaining motivation (creative drive to create or the like) by obtaining support from other people and connecting outputs of the next content.

Creators carrying out such processes may not maintain motivation without obtaining support, and it may be difficult to output content.

Twitter is an example of such an SNS service (NPL 1). Twitter is a communication SNS service, and is a blog service of a style in which one's current activities, current feelings, messages to other users, and the like are posted in a “tweet” style in short sentences of no more than 140 characters in Japanese.

Another example is pixiv (NPL 2). Pixiv is a membership site that specializes in posting and browsing of illustrations, cartoons, and novels, and is an SNS service for creators. According to pixiv, communication between a creator and a user can be given in the form of a cheering message.

Further, a technology of the communication system of PTL 1 has been proposed. This technology is a technology related to a communication system in which time and effort for transmission or reception of data (message) can be reduced when communication is performed between users via a communication line, time and effort of a transmission party searching for a partner who wants to communicate can be reduced, and only a required message can be received from a partner on a reception party, and thus it is possible to prevent unnecessary messages from being received.

### CITATION LIST

### Patent Literature

[PTL 1] Japanese Patent No. 3657187

### Non Patent Literature

[NPL 1] about.twitter.com/, (retrieved on 7 May 2021)
[NPL 2] www.pixiv.co.jp/service/, (retrieved on 7 May 2021)

### SUMMARY OF INVENTION

### Technical Problem

However, such methods have the following problems.

When an SNS is used, a creator can receive many support messages from many users. If these support messages have positive details, the creator's motivation can increase. However, in an SNS, anyone can freely make posts. Unfortunately, it is also true that there are users who post messages with negative details. Since an SNS does not have a function of filtering messages with negative details, negative messages may also be submitted to a creator once the messages are posted. When the negative messages are submitted to the creator, even if they are few, the creator may undergo mental shock depending on the content and may lose the creative drive to create mentally and not be able to output content.

In order to avoid such situations, a technology for filtering negative messages and preventing them from being submitted to creators is desired.

With regard to this, PTL 1 discloses a technology for rejecting posts from users who have ever transmitted messages with negative details. However, the system of PTL 1 performs determination for each user. Therefore, when rejection of a user who has transmitted messages with negative details once is set, even if the same users transmit messages with positive details, the messages are rejected. In this case, since messages with positive details are not submitted to a creator, opportunities to increase the motivation of the creator are taken away.

The present invention has been devised in view of such circumstances and an object of the present invention is to provide a communication system, method, and program capable of transmitting as many messages with positive details as possible without transmitting messages with negative details to creators so that contribution to improvement of the creative drive of the creators can be made.

### Solution to Problem

According to a first aspect of the present invention, to solve the foregoing problem, a communication system communicating with a plurality of client terminals via a communication line includes: a first reception unit configured to receive content transmitted from a first client terminal among the plurality of client terminals via the communication line; a posting unit configured to write the content received by the first reception unit on an electronic bulletin board which the plurality of client terminals are able to browse; a second reception unit configured to receive a message generated by one of the plurality of client terminals via the communication line with respect to the content written on the electronic bulletin board; a determination unit configured to determine whether the message is a message having positive details or a message having negative details based on details of the message received by the second reception unit; and a transmission unit configured to transmit the message determined by the determination unit to have the positive details to the first client terminal via the communication line.

### Advantageous Effects of Invention

According to the present invention, since as many messages with positive details as possible can be transmitted without transmitting messages with negative details to a creator, contribution to improvement of the creative drives of the creator can be made.

### BRIEF DESCRIPTION OF DRAWINGS

FIG. 1 is a conceptual diagram illustrating a network environment to which a communication system according to an embodiment of the present invention is applied.

FIG. 2 is a block diagram illustrating an electronic circuit configuration example of the communication system according to the embodiment of the present invention.

FIG. 3 is a diagram illustrating an example of content and messages to be transmitted and received.

FIG. 4 is a diagram illustrating a good cycle for enhancing creative drive of a creator expected by the communication system.

### DESCRIPTION OF EMBODIMENTS

A communication system to which a communication method according to an embodiment of the present invention is applied will be described below with reference to the drawings.

In description of the following embodiments, the same portions are denoted by the same reference numerals, and repeated description will be avoided.

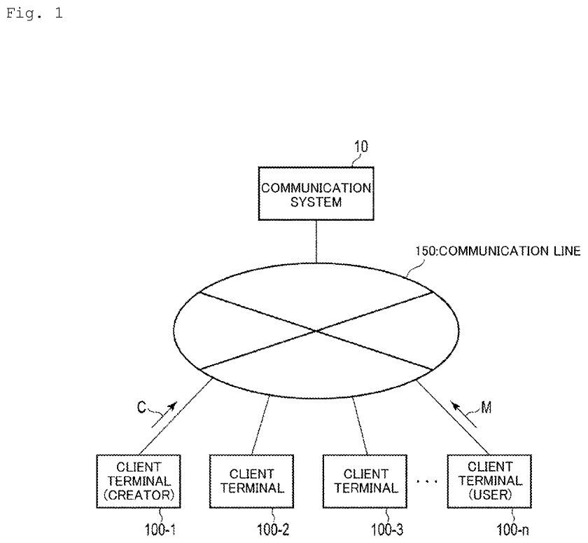

FIG. 1 is a conceptual diagram illustrating a network environment to which a communication system according to an embodiment of the present invention is applied.

As illustrated in FIG. 1, a communication system 10 can communicate with a plurality of client terminals 100 (−1, 2, 3, . . . , n: where n is an integer of 4 or more) through a communication line 150 such as the Internet.

The client terminal 100 is a terminal that is operated by a client and may be a mobile terminal such as a smartphone or a tablet, or a stationary PC.

In the present specification, a client is a creator who creates content such as a cartoon, a novel, a painting, a moving image, or a design, or a user who browses the content created by the creator and sends a support message to the creator.

Although four or more client terminals 100 are illustrated as examples in FIG. 1, the present invention is realized as long as there are at least one client terminal 100 (for example, a client terminal 100-1) operated by one creator and at least one client terminal (for example, a client terminal 100-n) operated by one user.

The network environment exemplified in FIG. 1 may include a LAN such as Ethernet (registered trademark) or a WAN to which a plurality of LANs are connected via a public line or a dedicated line. In the case of the LAN, the LAN includes a number of subnets via routers as necessary. In the case of the WAN, a firewall or the like for connecting to a public line is appropriately provided, but the illustration and detailed description thereof are omitted here.

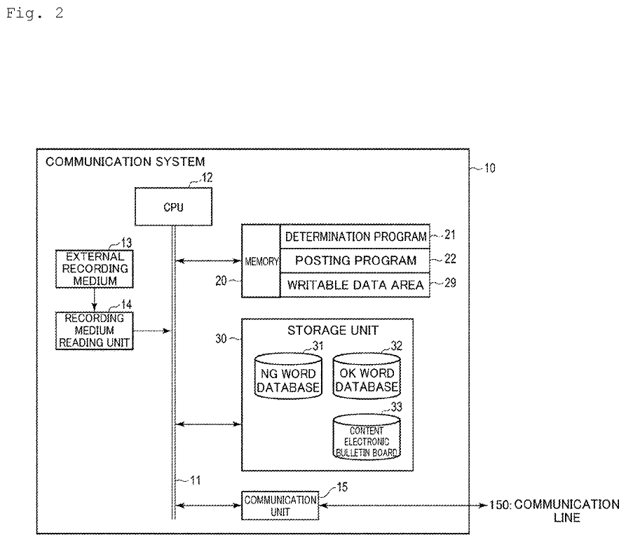

FIG. 2 is a block diagram illustrating an electronic circuit configuration example of the communication system according to the embodiment of the present invention.

The communication system 10 includes a CPU 12, a recording medium reading unit 14, a communication unit 15, a memory 20, and a storage unit 30 connected to each other via a bus 11.

The memory 20 stores a determination program 21 and a posting program 22.

The CPU 12 which is a computer controls an operation of each circuit unit according to each of the programs 21 and 22 stored in the memory 20, and operates as will be described below in cooperation with software and hardware.

Each of the programs 21 and 22 may be stored in advance in the memory 20 or may be read from an external recording medium 13 such as a memory card to the memory 20 via the recording medium reading unit 14 to be stored. The programs 21 and 22 cannot be rewritten.

The memory 20 secures a writable data area 29 as an area where rewritable data is stored in addition to such a user unrewritable area.

The storage unit 30 is configured with, for example, a solid state drive (SSD), a hard disk drive (HDD), or the like and stores an NG word database 31 which stores NG words having negative meanings (for example, “trivial,” “boring,” “don't write,” and the like), an OK word database 32 that stores OK words having positive meanings (for example, “humorous,” “splendid,” “pleasure,” “expectation,” etc.), and a content electronic bulletin board 33 in which content posted by creators is written. The content written in the content electronic bulletin board 33 can be browsed by the client terminal 100.

The communication unit 15 receives content C transmitted from one (for example, a client terminal 100-1 operated by a creator) of the plurality of client terminals 100 via a communication line 150, and outputs the content C to the memory 20.

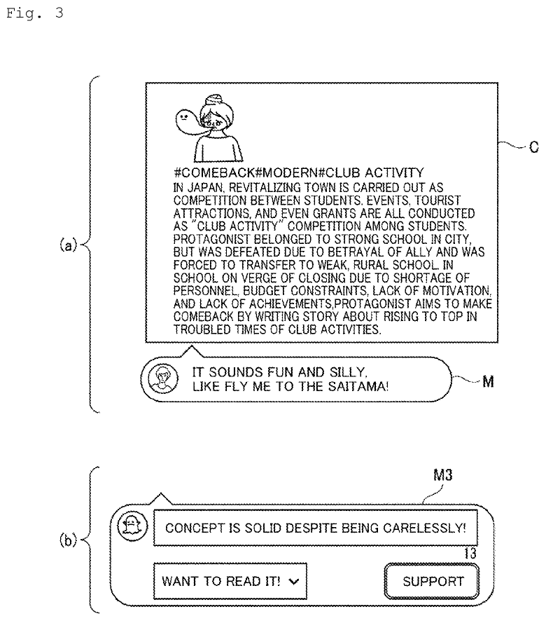

FIG. 3 is a diagram illustrating an example of content and messages to be transmitted and received.

The posting program 22 writes the content C output from the communication unit 15 to the memory 20 in the content electronic bulletin board 33.

The content C written in the content electronic bulletin board 33 can be browsed by the plurality of client terminals 100.

Accordingly, for example, a user operating the client terminal 100-n can access the content electronic bulletin board 33 from the client terminal 100-n and can browse the content C created by the creator and written in the content electronic bulletin board 33 as illustrated in FIG. 3 (a). In the example illustrated in FIG. 3 (a), the content C is a posting of the creator at an idea stage. The user can view the posting of the idea stage and transmit a message M such as an impression for the content C and a support for a creator to the communication system 10.

The transmitted message M is received by the communication unit 15 of the communication system 10 via the communication line 150. The communication unit 15 outputs the received message M to the control unit 20.

In the example illustrated in FIG. 3 (a), only one message M for the content C is illustrated, but many messages can be actually transmitted. The message may include not only a message having positive details but also a message having negative details in some cases.

The determination program 21 determines whether the message M is negative (for example, abuse or slanderous) content based on the content of the message M output from the communication unit 15 to the memory 20.

Specifically, the determination program 21 accesses the NG word database 31 to determine whether the NG word stored in the NG word database 31 is included in the message M. When the NG word is included, the determination program 21 determines that the message M is a message M1 having negative details. When the NG word is not included, the determination program 21 determines that the message M is a message M2 which does not have negative details.

Further, the determination program 21 accesses the OK word database 32, and determines whether an OK word stored in the OK word database 32 is included in the message M2 which does not have negative details. When the OK word is included, the determination program determines that the message M2 is a message M3 which has positive details. In this way, the determination program 21 filters messages having negative details from the message M from the user and extracts the message M3 which has positive details.

The determination program 21 outputs the message M3 having positive details to the communication unit 15.

In response to this, the communication unit 15 transmits the message M3 to the client terminal 100-1 of the creator via the communication line 150. Accordingly, as Exemplified in FIG. 3 (b), the message M3 having positive details is displayed from the client terminal 100-1 of the creator.

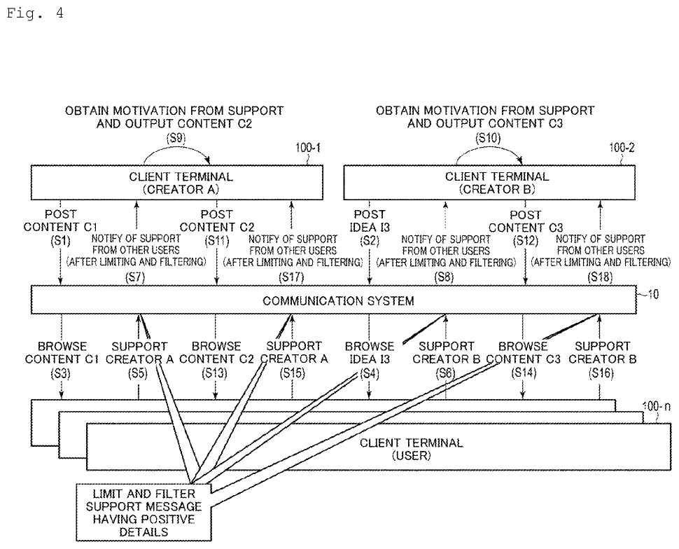

By the filtering function of the determination program 21 as described above, the creator is notified of only the message M3 of the positive details without being notified of the message of the negative details, the message M3 of positive details can enhance the creative drive of the creator without losing the creative drives due to the message of negative details. Accordingly, it is expected to implement a good cycle for enhancing a creative drive of the creator, as will be described below with reference to FIG. 4.

FIG. 4 is a diagram illustrating a good cycle for enhancing a creative drive of a creator expected by the communication system 10.

A creator A operates the client terminal 100-1 to post content C1 (for example, cartoon) to the communication system 10 (S1). The posted content C1 is written in the content electronic bulletin board 33 in the communication system 10.

A creator B operates a client terminal 100-2 to post an idea I3 (for example, a material of a cartoon) to the communication system 10 (S2). The posted idea I3 is also written in the content electronic bulletin board 33 in the communication system 10.

A user operates the client terminal 100-n to a content electronic bulletin board 33 of the communication system 10 and browse the content C1 and the idea I3 (S3 and S4).

When the user browses the content C1 and the idea I3, the user operates the client terminal 100-n to create the message M for the creators A and B and post the message M to the communication system 10 (S5 and S6).

In the communication system 10, the posted messages M are filtered by the above-described determination program 21, and the creators A and B are notified of the message M3 having positive details (S7 and S8).

The creator A obtains motivation from the message M3 having positive details, performs a creation activity energetically, and outputs content C2 (for example, a continuation of the cartoon of the content C1) (S9). Then, the content C2 is posted from the client terminal 100-1 to the communication system 10 (S11). The posted content C2 is written in the content electronic bulletin board 33.

The creator B also obtains motivation from the message M3 having the positive details, performs a creation activity energetically, and outputs the content C3 (for example, a cartoon actually drawn based on the material of the idea I3) (S10). Then, the content C3 is posted from the client terminal 100-2 to the communication system 10 (S12). The posted content C3 is also written in the content electronic bulletin board 33.

The user operates the client terminal 100-n to access the content electronic bulletin board 33 of the communication system 10 and browse the content C2 and the content C3 (S13 and S14).

When the user browses the content C2 and the content C3, the user operates the client terminal 100-n to create the message M for the creators A and B, and posts the message M to the communication system 10 (S15 and S16).

In the communication system 10, the posted support message M is filtered by the above-described determination program 21, and the creators A and B are notified of the message M3 having positive details (S17 and S18).

The creators A and B can obtain motivation for creating new content from the message M3 having the positive details.

Of the steps illustrated in FIG. 4, processing related to the creator A (the steps of odd numbers) and processing related to the creator B (the steps of even numbers) are performed independently from each other, or may be performed at other times or at the same time.

As described above, in the communication system 10 according to the embodiment, it is possible to transmit only a message having positive details without transmitting a message having negative details to the creators. Accordingly, without losing the creative drives of the creators, it is possible to contribute to the implementation of a good cycle for enhancing the creative drive, as exemplified in FIG. 4.

The above-described methods can be stored as a program (software means) that can be executed by a calculator (computer), in a recording medium (storage medium) such as a magnetic disk (a floppy (registered trademark) disk, a hard disk, or the like), an optical disc (a CD-ROM, a DVD, an MO, or the like), a semiconductor memory (a ROM, a RAM, a flash memory, or the like) or transmitted and distributed using a communication medium. The program stored on the medium side includes a setting program for configuring, in the computer, software means (including not only an execution program but also tables and data structures) to be executed by the computer. The calculator that implements the above-described communication system 10 reads the program recorded on the recording medium, constructs the software means by the setting program in some cases, and executes the above-described steps of processing by the software means controlling the operation. The recording medium described in the present specification is not limited to a recording medium for distribution, and includes a storage medium such as a magnetic disk or a semiconductor memory provided inside the calculator or in a device connected via a network.

The present invention is not limited to the above embodiments, and can be modified in various forms without departing from the scope of the present invention at the implementation stage. Further, the foregoing embodiment include various inventions, and various inventions can be extracted by combinations selected from the plurality of components disclosed herein. For example, as long as the problem can be solved and the effects can be achieved although some of the constituents described in the embodiment are removed, a configuration in which the constituents have been removed can be extracted as an invention.

Further, in the foregoing embodiment, an example of the configuration in which the communication system 10 is implemented by a single hardware has been described. However, the communication system 10 to which the communication method according to the embodiment of the present invention is applied is not limited to a configuration implemented by single hardware, and is configured to combine a plurality of servers as in a cloud. That is, the configuration can be implemented using one or more processors and such a configuration is also understood that it pertains to the technical scope of the present invention.

### REFERENCE SIGNS LIST

10 Communication system
11 Bus
12 CPU
13 External recording medium
14 Recording medium reading unit
15 Communication unit
20 Memory
21 Program
22 Posting program
29 Writable data area
30 Storage unit
31 NG word database
32 OK word database
33 Content electronic bulletin board
100 Client terminal
150 Communication line
A, B Creator
C Content
I Idea
M Message

1. A communication system communicating with a plurality of client terminals via a communication line, the communication system comprising:
a first reception unit, comprising one or more processors, configured to receive content transmitted from a first client terminal among the plurality of client terminals via the communication line;
a posting unit, comprising one or more processors, configured to write the content received by the first reception unit on an electronic bulletin board which the plurality of client terminals are able to browse;
a second reception unit, comprising one or more processors, configured to receive a message generated by one of the plurality of client terminals via the communication line with respect to the content written on the electronic bulletin board;
a determination unit, comprising one or more processors, configured to determine whether the message is a message having positive details or a message having negative details based on details of the message received by the second reception unit; and
a transmission unit, comprising one or more processors, configured to transmit the message determined by the determination unit to have the positive details to the first client terminal via the communication line.

2. The communication system according to claim 1, further comprising an NG word database configured to store an NG word which is a word which has a negative meaning,
wherein the determination unit is configured to determine that the message is a message having negative details when the message includes the NG word stored in the NG word database.

3. The communication system according to claim 1, further comprising an OK word database storing an OK word that is a word having a positive meaning,
wherein the determination unit is configured to that the message is a message having positive details when the message includes the OK word stored in the OK word database.

4. The communication system according to claim 1, wherein the message is generated by one of the plurality of client terminals other than the first client terminal.

5. The communication system according to claim 1, wherein the first reception unit, the second reception unit, and the transmission unit are the same communication device.

6. A communication method performed by a communication system communicating with a plurality of client terminals via a communication line, the communication method comprising,
receiving content transmitted from a first client terminal among the plurality of client terminals via the communication line;
writing the received content on an electronic bulletin board which the plurality of client terminals are able to browse;
receiving a message generated by one of the plurality of client terminals via the communication line with respect to the content written on the electronic bulletin board;
determining whether the message is a message having positive details or a message having negative details based on details of the received message; and
transmitting the message determined in the determination to have the positive details to the first client terminal via the communication line.

7. A non-transitory computer readable medium storing a program, wherein execution of the program causes a processor to perform operations comprising:
receiving content transmitted from a first client terminal among a plurality of client terminals via a communication line;
writing the received content on an electronic bulletin board which the plurality of client terminals are able to browse;
receiving a message generated by one of the plurality of client terminals via the communication line with respect to the content written on the electronic bulletin board;
determining whether the message is a message having positive details or a message having negative details based on details of the received message; and
transmitting the message determined in the determination to have the positive details to the first client terminal via the communication line.
